(19) United States
(12) Patent Application Publication
(10) Pub. No.: US 2005/0144507 A1
(43) Pub. Date: Jun. 30, 2005

(54) Method and apparatus for remotely debugging an application program over the internet

(76) Inventors: Kuo-Chun Lee, Fremont, CA (US); Tsung-Yen (Eric) Chen, Fremont, CA (US)

Correspondence Address: VICTOR H. OKUMOTO, P.O. BOX 6120, FREMONT, CA, 94538, US

(21) Appl. No.: 11/030,691

(22) Filed: Jan. 6, 2005

Related U.S. Application Data
(63) Continuation of application No. 09/664,941, filed on Sep. 19, 2000.

(51) Int. Cl. G06F 11/00

(52) U.S. Cl. 714/4

(57) ABSTRACT

A method and apparatus for remotely debugging an application program over the Internet is described. A software vendor provides an interface program along with an application program to a customer. The interface program detects a debug request initiated by a customer operator on a customer computer, and establishes a connection with a debug program on a vendor computer over the Internet. The interface program takes over control of the application program from the customer operator, and takes various actions including running a diagnostic sequence received from the debug program on the application program to debug the application program.

### FIELD OF THE INVENTION

The present invention generally relates to methods for software vendors to provide technical assistance to their customers and in particular, to a method and apparatus for remotely debugging an application program over the Internet.

### BACKGROUND OF THE INVENTION

It is common business practice for customers to purchase application programs or software over the Internet by downloading them from vendor web sites. This method of purchasing software is both convenient for customers, and cost effective for vendors. Customers do not waste time or gas traveling to and looking for retail stores stocking the software, and vendors eliminate middleman expenses and avoid packaging and media costs.

Unfortunately, when customers experience problems using the purchased software, the prevalent method of debugging those problems continues to be the old fashioned method of calling in for customer telephone assistance. This approach results too often in long waits to talk to technical support personnel, and limited diagnostic assistance once such personnel become available since it may be difficult for them to replicate the customer's problem on their computers.

### OBJECTS AND SUMMARY OF THE INVENTION

Accordingly, it is an object of the present invention to provide an improved method and apparatus for software vendors to provide technical assistance to their customers.

Another object is to provide a method and apparatus for software vendors to provide technical assistance to their customers over the Internet.

Still other objects are to provide a method and apparatus for remotely debugging an application program over the Internet.

These and additional objects are accomplished by the various aspects of the present invention, wherein briefly stated, one aspect is a method implemented in a client computer for remotely debugging an application program over the Internet, comprising: (a), establishing a connection between the client computer and a server computer over the Internet; (b), receiving a request from a debug program of the server computer; (c), causing an application program of the client computer to generate a response to the request; and (d), transmitting an indication of the response back to the debug program; and (e), repeating (b), (c) and (d) multiple times so as to run the application program through a diagnostic sequence.

In another aspect, an apparatus for remotely debugging an application program over the Internet, comprises a client computer having an interface program for: (a), establishing a connection between the client computer and a server computer over the Internet; (b), receiving a request from a debug program of the server computer; (c), causing an application program of the client computer to generate a response to the request; and (d), transmitting an indication of the response back to the debug program; and (e), repeating (b), (c) and (d) multiple times so as to run the application program through a diagnostic sequence.

In another aspect, a method implemented in a client computer for remotely debugging an application program over the Internet, comprises: (a), establishing a connection between the client computer and a server computer over the Internet; (b), receiving a request from a debug program of the server computer; (c), causing an application program of the client computer to respond to the request; (d), generating a graphics file including pixel information for a graphics image displayed on a display screen of the client computer; and (e), transmitting the graphics file to the server computer so that the graphics image is displayable on a display screen of the server computer.

In another aspect, an apparatus for remotely debugging an application program over the Internet, comprises a client computer having an interface program for: (a), establishing a connection between the client computer and a server computer over the Internet; (b), receiving a request from a debug program of the server computer; (c), causing an application program of the client computer to respond to the request; (d), generating a graphics file including pixel information for a graphics image displayed on a display screen of the client computer; and (e), transmitting the graphics file to the server computer so that the graphics image is displayable on a display screen of the server computer.

In another aspect, a method implemented in a server computer for remotely debugging an application program over the Internet, comprises: (a), receiving a request from a client computer over the Internet to debug an application program of the client computer; (b), transmitting back to the client computer a request for the application program to take an action; (c), receiving an indication of a response of the application program action back from the client computer; and (d), repeating (b) and (c) multiple times so as to run the application program through a diagnostic sequence.

In another aspect, an apparatus for remotely debugging an application program over the Internet, comprises a server computer having a debug program for: (a), receiving a request from a client computer over the Internet to debug an application program of the client computer; (b), transmitting back to the client computer a request for the application program to take an action; (c), receiving an indication of a response of the application program action back from the client computer; and (d), repeating (b) and (c) multiple times so as to run the application program through a diagnostic sequence.

In yet another aspect, a method implemented in a server computer for remotely debugging an application program over the Internet, comprises: (a), receiving a request from a client computer over the Internet to debug an application program of the client computer; (b), transmitting back to the client computer a request for the application program to take an action; (c), receiving a graphics file including pixel information for a graphics image displayed on a display screen of the client computer in response to the action; (d), displaying the graphics image on a display screen of a server computer; and (e), repeating (b) through (d) multiple times so as to allow a user of the server computer to interactively debug the application program by transmitting requests for the application program to take certain actions in consideration of graphics images defined in graphics files received from the client computer in response to prior such requests.

In still another aspect, an apparatus for remotely debugging an application program over the Internet, comprises a server computer having a debug program for: (a), receiving a request from a client computer over the Internet to debug an application program of the client computer; (b), transmitting back to the client computer a request for the application program to take an action; (c), receiving a graphics file including pixel information for a graphics image displayed on a display screen of the client computer in response to the action; (d), displaying the graphics image on a display screen of a server computer; and (e), repeating (b) through (d) multiple times so as to allow a user of the server computer to interactively debug the application program by transmitting requests for the application program to take certain actions in consideration of graphics images defined in graphics files received from the client computer in response to prior such requests.

Additional objects, features and advantages of the various aspects of the present invention will become apparent from the following description of its preferred embodiments, which description should be taken in conjunction with the accompanying drawings.

### BRIEF DESCRIPTION OF THE DRAWINGS

FIG. 1 illustrates a diagram of a system for remotely debugging an application program over the Internet.

FIG. 2 illustrates a client display screen under control of an application program.

FIG. 3 illustrates a client display screen under control of an interface program.

FIG. 4 illustrates a flow diagram of a method implemented in a client computer for remotely debugging an application program over the Internet.

FIG. 5 illustrates a flow diagram of a method implemented in a server computer for remotely debugging an application program over the Internet.

### DETAILED DESCRIPTION OF THE PREFERRED EMBODIMENT

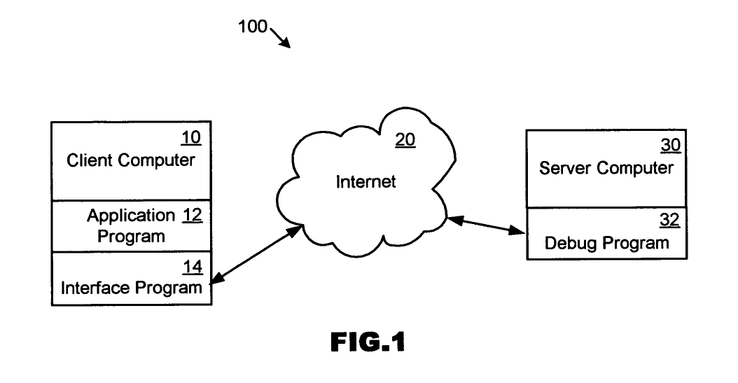

FIG. 1 illustrates a diagram of a system 100 for remotely debugging an application program 12 over the Internet 20. Included in the system 100 are a client computer 10 having an application program 12 and an interface program 14 residing on it, and a server computer 30 having a debug program 32 residing on it. A customer of the application program 12 controls the client computer 10, and a vendor of the application program 12 controls the server computer 30. The client computer 10 and the server computer 30 are coupled through the Internet 20. The debug program 32 facilitates preprogrammed and vendor debugging of the application program 12.

The interface program 14 controls the application program 12 and communicates with the debug program 32 during the debug mode. When the debug program 32 transmits a request to be acted upon by the application program 12, the interface program 14 receives the request and causes the application program 12 to generate a response to the request. The interface program 14 then transmits an indication of the response back to the debug program 32.

In one form of indication, the interface program 14 simply returns the response to the debug program 32. In another form of indication, the interface program 14 captures pixel information for a graphics image on the display screen of the client computer 10 from a frame buffer associated with the client computer 10, converts the pixel information into a graphics file of a selected graphics file format, and transmits the graphics file to the debug program 32. The graphics file format may be any one of a number of standard formats such as JPEG, GIF or TIF. This form of indication allows the vendor operator to see what is being displayed on the display screen of the client computer 10. This is especially useful when the vendor operator is unable to replicate the response generated by the application program 12 running on the client computer 10 with a corresponding response generated by a copy of the application program 12 running on the server computer 30.

As used herein, the purchaser of the application program 12 is referred to as the “customer”, the operator or user of the client computer 10 is referred to as the “customer operator”, the vendor company of the application program 12 is referred to as the “vendor”, and the operator or user of the server computer 30 is referred to as the “vendor operator”. Vendor operators are typically customer technical support personnel. The interface program 14 is typically sold or licensed by the vendor along with the application program 12.

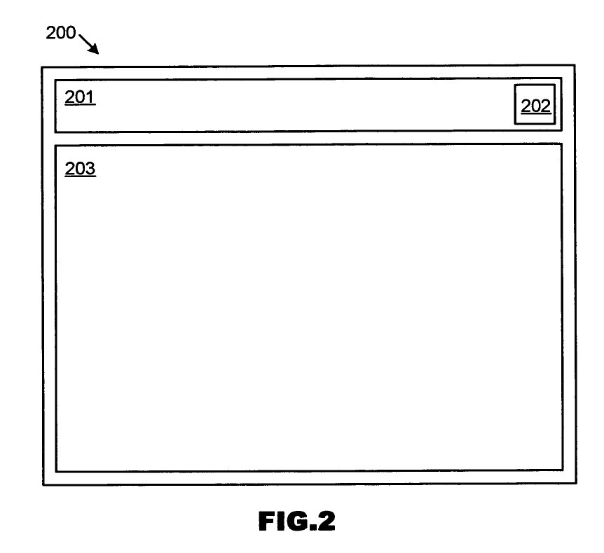

FIG. 2 illustrates a simplified example of the client display screen 200 under the control of the application program 12. A tool bar area 201 includes numerous buttons (not shown) for typical customer operator control input, and a debug button 202. The interface program 14 is activated when the customer operator clicks the debug button 202. Upon its activation, the interface program 14 takes control of the application program 12, establishes a connection with the debug program 32, receives requests from the debug program 32, and transmits responses or indications of responses back to the debug program 32. A client work area 203 is also shown on the client display screen 200. The tool bar area 201 and the client work area 203 are legacies of the application program 12, whereas the debug button 202 facilitates an added feature for remotely debugging the application program 12 over the Internet 20.

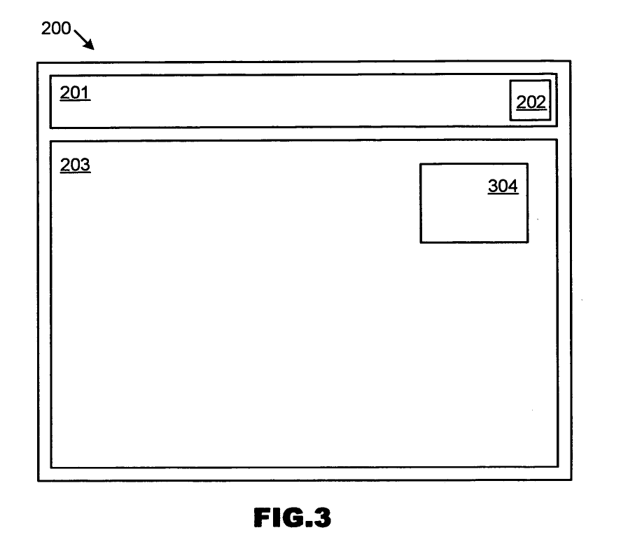

FIG. 3 illustrates a simplified example of the client display screen 200 under the control of the interface program 14. The tool bar area 201 is generally no longer responsive to customer operator input, except for the debug button 202. When the customer operator clicks the debug button 202 in this case, the interface program 14 is deactivated and control of the application program 12 returns to the customer operator. Superimposed over the client work area 203 is an exemplary window 304 used for communications between the customer operator and the debug program 32 or a vendor operator.

In one use of the window 304, the interface program 14 prompts the customer operator for a user identification and password. After the customer operator provides the requested information, the interface program 14 transmits the user identification and password to the debug program 32 for verification. In another use of the window 304, the interface program 14 presents a check-the-box type questionnaire to the customer operator to facilitate efficient diagnosis of the problem to be debugged. After the customer operator clicks the appropriate boxes, the interface program 14 transmits the information to the debug program 32, which in turn, initiates appropriate diagnostic sequences corresponding to each checked box. In still another use of the window 304, an instant messaging or chat room type area facilitates communication back and forth between the customer operator and the vendor operator to further facilitate diagnosis of the problem to be debugged.

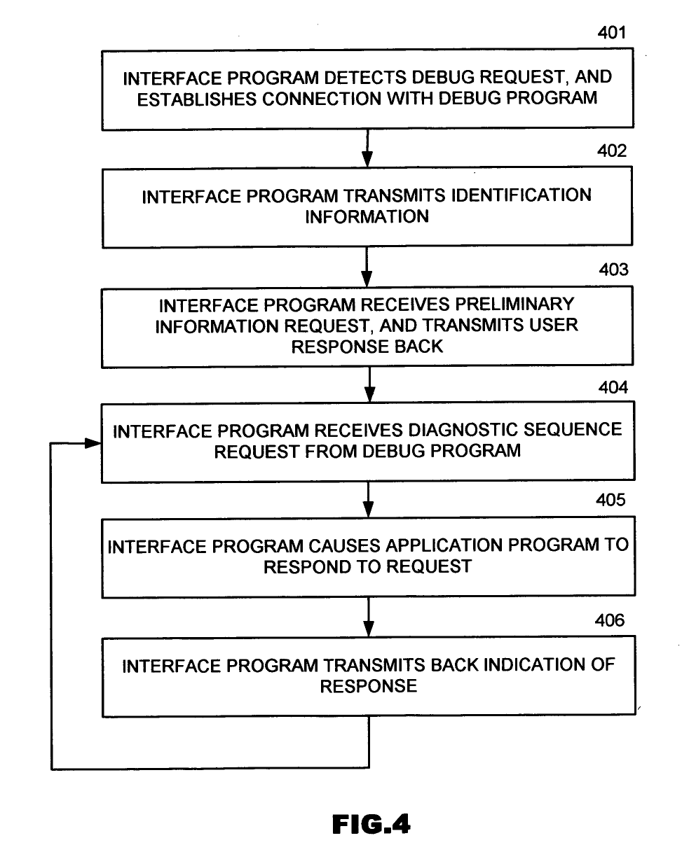

FIG. 4 illustrates a flow diagram of a method implemented in a client computer 10 for remotely debugging an application program 12 over the Internet 20. In 401, the interface program 14 detects a debug request initiated by the customer operator clicking the debug button 202, and as a result, becomes activated. After becoming activated, the interface program 14 takes control of the application program 12 and establishes a connection with the debug program 32 of the server computer 30 over the Internet 20. The interface program 14 knows the Internet address of the debug program 32 in this case, because it has been preprogrammed into the interface program 12 by the vendor.

In 402, the interface program 14 transmits identification information to the debug program 32 of the server computer 30 over the Internet 20. A first set of identification information includes identification of the application program 12, and identification of the client computer 10. This information allows the debug program 32 to verify that the application program 12 is still under warranty or maintenance contract, and that the client computer 10 is authorized to run the application program 12. The identifications of the application program and client computer 10 may be sent automatically by the interface program 14 according to its programming after establishing connection with the debug program 32, or sent by the interface program 14 after the debug program 32 has made a request for such information to the interface program 14. A second set of identification information includes a user identification and a password. The customer operator provides this information in a conventional fashion after being prompted by the interface program 14. Providing the user identification and password allows the debug program 32 to verify that the customer operator is authorized to contact the vendor company for debug support. If verification fails for either the first or second set of identification information, the interface program 14 displays a failure message received from the debug program 32 in the window 304. The interface program 14 is then deactivated, and control of the application program 12 is passed back to the customer operator.

In 403, the interface program 14 receives a request for preliminary information from the debug program 32. The preliminary information request may take the form of a fill-in-the-box questionnaire preprogrammed in and automatically transmitted by the debug program 32, or instant messaging or chat room type questions from the vendor operator. In either case, the questionnaire or questions are displayed in the window 304. The customer operator then responds to the questionnaire by checking the appropriate boxes, or answers the instant messaging or chat room type questions, as the case may be, and the interface program 14 transmits the information back to the debug program 32. The purpose of such preliminary information is to make the debug process more efficient, such as narrowing the choices of diagnostic sequences to take in subsequent debugging activities.

In 404 through 406, the interface program 14 takes certain actions in response to a diagnostic sequence received from the debug program 32. The diagnostic sequence may be preprogrammed into the debug program 32, or it may be provided to the debug program 32 from the vendor operator. It may also be a combination of a preprogrammed diagnostic sequence and vendor operator provided diagnostic sequence. In this case, the diagnostic sequence typically starts out as a preprogrammed diagnostic sequence that is paused at some point by the vendor operator. The vendor operator then takes over control of the debug program 32 at this point, and generates his or her own diagnostic sequence so as to interactively debug the application program 12.

In 404, the interface program 14 receives a request from the debug program 32 to be redirected to the application program 12. As previously described, the request is one of a diagnostic sequence directed to debug the application program 12. In 405, the interface program 14 causes the application program 12 to generate a response to the request. In 406, the interface program 14 transmits an indication of the response back to the debug program 32. As previously described, the indication may be the response itself, or a graphics file including pixel information for a graphics image displayed on the display screen of the client computer 10. Then 404 through 406 are repeated multiple times so as to run the application program 12 through the diagnostic sequence.

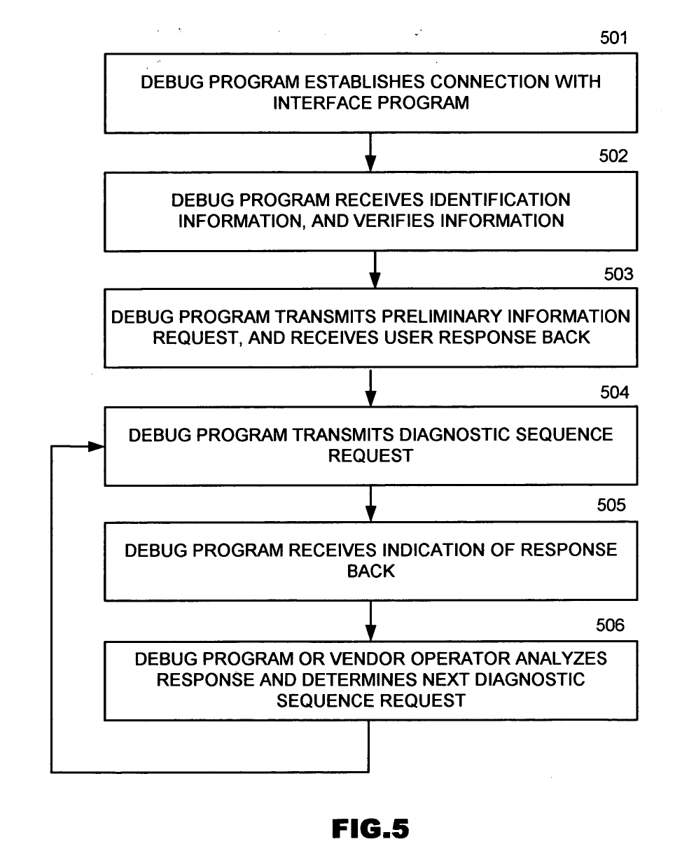

FIG. 5 illustrates a flow diagram of a method implemented in a server computer 30 for remotely debugging an application program 12 over the Internet 20. In 501, the debug program 32 establishes a connection with the interface program 14 of the client computer 10, as further described in reference to 401. In 502, the debug program 32 receives identification information from the interface program 14, and verifies such information, as further described in reference to 402. In 503, the debug program 32 transmits a preliminary information request to the interface program 14, and receives customer operator responses back, as further described in reference to 403. By performing 504 through 506 multiple times, the debug program 32 or vendor operator generates and provides the diagnostic sequence to the interface program 14 in order to debug the application program 12, as further described in reference to 404 through 406. In particular, in 504, the debug program 32 transmits a diagnostic sequence request for the application program 12 to the interface program 14. In 505, the debug program 32 receives an indication of the response of the application program 12 to the diagnostic sequence request back from the interface program 14. In 506, the debug program 32 analyzes the response and determines a next diagnostic sequence request for the application program 12 according to a preprogrammed diagnostic sequence, or the vendor operator analyzes the response and determines a next diagnostic sequence request for the application program 12 according to a vendor operator determined diagnostic sequence.

Although the various aspects of the present invention have been described with respect to a preferred embodiment, it will be understood that the invention is entitled to full protection within the full scope of the appended claims.

1-37. (canceled)

38. A method for remotely debugging an application program over the Internet, comprising:
configuring an application program such that the application program displays a debug selector on a display screen and responds to a user of the application program selecting the debug selector by initiating remote debugging of the application program over the Internet.

39. The method according to claim 38, wherein the debug selector is a debug button and selecting the debug selector comprises clicking on the debug button.

40. The method according to claim 39, wherein the debug button is included in a toolbar area on the display screen.

41. The method according to claim 38, further comprising: configuring the application program to interact with an interface program such that control of the application program is transferred to the interface program upon the user selecting the debug selector while the application program is being controlled by the user.

42. The method according to claim 41, further comprising: configuring the application program to interact with the interface program such that control of the application program is transferred back to the user of the application program upon the user deselecting the debug selector while the application program is being controlled by the interface program.

43. The method according to claim 41, further comprising: configuring the interface program to establish a connection with a debug program over the Internet after receiving control of the application program so that the debug program may perform remote debugging of the application program through the interface program.

44. The method according to claim 43, wherein an Internet address of the debug program is programmed into the interface program so that the interface program may contact the debug program over the Internet.

45. The method according to claim 43, further comprising: configuring the interface program to transmit information to the debug program that is indicative of whether or not the application program is authorized to initiate remote debugging of the application program.

46. The method according to claim 43, further comprising: configuring the interface program to transmit information to the debug program that is indicative of whether or not the user of the application program is authorized to initiate remote debugging of the application program.

47. The method according to claim 43, further comprising: configuring the interface program to receive a debug instruction from the debug program, cause the application program to generate an application program response to the debug instruction, and transmit information of the application program response back to the debug program.

48. The method according to claim 47, further comprising: configuring the interface program to receive a preliminary information request from the debug program, display the preliminary information request on the display screen in an area responsive to input from the user so that the user may generate a user response to the preliminary information, and transmit the user response back to the debug program.

49. The method according to claim 48, wherein the preliminary information request is in the form of a fill-in-the-box questionnaire that is preprogrammed in and automatically transmitted by the debug program prior to remote debugging of the application program.

50. The method according to claim 48, wherein the debug instruction is part of one of a plurality of diagnostic sequences preprogrammed into the debug program and selected according to the user response to the preliminary information.

51. A method for remotely debugging an application program over the Internet, comprising: providing an application program configured to display a debug selector on a display screen and respond to a user of the application program selecting the debug selector by initiating remote debugging of the application program over the Internet.

52. The method according to claim 51, further comprising: providing an interface program, wherein the application program is further configured to interact with the interface program such that control of the application program is transferred to the interface program upon the user selecting the debug selector while the application program is being controlled by the user.

53. The method according to claim 52, wherein the interface program to configured to establish a connection with a debug program over the Internet after receiving control of the application program so that the debug program may perform remote debugging of the application program through the interface program.

54. The method according to claim 53, wherein the interface program is further configured to receive a debug instruction from the debug program, cause the application program to generate an application program response to the debug instruction, and transmit information of the application program response back to the debug program.

55. The method according to claim 54, wherein the interface program is further configured to receive a preliminary information request from the debug program, display the preliminary information request on the display screen in an area responsive to input from the user so that the user may generate a user response to the preliminary information, and transmit the user response back to the debug program.

56. The method according to claim 55, wherein the debug instruction is part of one of a plurality of diagnostic sequences preprogrammed into the debug program and selected according to the user response to the preliminary information.

57. A method for remotely debugging an application program over the Internet, comprising: generating a plurality of application programs individually configured so as to display a debug selector on a display screen and respond to selection of the debug selector by initiating remote debugging of the application program over the Internet by a debug program residing on a server operated for a vendor of the plurality of application programs, and commercially distributing the plurality of application programs.
